(19) United States
(12) Patent Application Publication
(10) Pub. No.: US 2026/0131690 A1
(43) Pub. Date: May 14, 2026

(54) POWER AND ENERGY RESERVATION SYSTEM (PERS) AND METHOD FOR ELECTRIC VEHICLE (EV) CHARGING

(71) Applicant: BarrellCharge Solutions, Inc., Austin, TX (US)

(72) Inventors: Steve A. Tarnowsky, West Bloomfield, MI (US); William D. Marsh, Austin, TX (US)

(21) Appl. No.: 19/442,227

(22) Filed: Jan. 7, 2026

Related U.S. Application Data
(62) Division of application No. 19/169,085, filed on Apr. 3, 2025.
(60) Provisional application No. 63/637,146, filed on Apr. 22, 2024.

(51) Int. Cl. B60L 53/66; B60L 53/16; B60L 53/62; B60L 53/65; G06Q 10/02; G06Q 30/0283

(52) U.S. Cl. CPC B60L 53/665; B60L 53/62; B60L 53/65; G06Q 10/02; G06Q 30/0284; B60L 53/16

(57) ABSTRACT

Disclosed are embodiments of a power and energy reservation system (PERS) enabling a user to reserve energy or minimum peak power at electric vehicle supply equipment (EVSE) having electric vehicle (EV) charging couplers to enable charging of an EV. One embodiment, among others, is a method that can be broadly summarized by the following steps: enabling the user to reserve (a) a charging event at a specific site having a plurality of EVSEs during a specified time window and (b) a charging process that exceeds a predetermined minimum threshold; determining availability of site couplers at the site based upon the predetermined minimum threshold; and communicating a reserved site coupler identification to the user based upon the availability. Another embodiment, among others, is a reservation system that has a computer-based architecture and that is programmed to perform the aforementioned steps and communicate with computer-based client devices.

### CLAIM OF PRIORITY

This application is a divisional of application Ser. No. 19/169,085, filed Apr. 3, 2025, which claims priority to and the benefit of application No. 63/637,146, filed Apr. 22, 2024, both of which are incorporated herein by reference in their entireties.

### FIELD OF THE INVENTION

The embodiments of the present disclosure generally relate to electric charging stations, or systems, for electric vehicles (EVs), and more particularly, to systems for enabling users to reserve charging events at electric vehicle supply equipment (EVSE) with minimum power or energy thresholds.

### BACKGROUND OF THE INVENTION

Electric vehicle supply equipment (EVSE) supplies electricity to an electric vehicle (EV). Commonly called charging stations or charging docks, they provide electric power to the EV and use that to recharge the EV's batteries. EVSE systems include the electrical conductors, related equipment, software, and communications protocols that deliver energy efficiently and safely to the vehicle. In general, EVSE equipment is classified as Level 1 (120 volts AC), level 2 (240 volts, AC), and DC fast charger (480 volts DC and higher).

As the EV market penetration increases, there will be growing demand for public charging. U.S. patent application no. US 2012/0233077 A1, which is incorporated herein by reference and which has a common inventor with the present invention disclosure, describes an electric charging station reservation system and method that enable advance reservation of a charging station for an EV based at least in part upon expected arrival time.

Although parking and a charging site coupler may be available, any particular EV supply equipment (EVSE) installation will be power constrained by its electric utility grid service capacity. If there is more than a single EV charging at a particular EVSE installation, then power derating is typically deployed to ensure that usage does not exceed its grid capacity. This operation can result in a given charging event that occurs at lower than rated power for the specific dispenser being used within the installation, thus taking more time to deliver a given amount of energy to the EV than what may have been expected. While this situation is common and acceptable to EV users most of the time, there will likely be situations where a particular user may be willing to pay a premium to reserve a minimum peak power from a particular EVSE dispenser at a given installation.

### SUMMARY OF THE INVENTION

Disclosed are embodiments of power and energy reservation systems (PERS) and methods for enabling a user to reserve a selected amount of energy or a minimum delivered peak power at electric vehicle supply equipment (EVSE) having electric vehicle (EV) charging couplers to enable charging of an EV with electricity.

One embodiment, among others, is a method that can be broadly summarized by the following steps: enabling the user to reserve (a) a charging event at a specific site having a plurality of EVSEs during a specified time window and (b) a charging process that exceeds a predetermined minimum threshold; determining availability of site couplers at the site based upon the predetermined minimum threshold; and communicating a reserved site coupler identification (for example, an electronic token) to the user based upon the availability. The reserved predetermined minimum threshold is one of the following: a reserved minimum peak power (RMPP), a minimum reserved energy (RE), or a minimum driving range (which in effect corresponds to a minimum RE). The predetermined minimum threshold can also be part of a range that is input by the user.

Another embodiment, among others, is a reservation system that has a computer-based architecture and that is programmed to perform the aforementioned steps that are recited in the previous paragraph and to communicate with users via respective computer-based client devices.

Still another embodiment, among others, is a method for reserving an electric charging station for a vehicle having a controller and a battery and a charging process at the electric charging station that meets or exceeds a charging threshold. The method can be broadly summarized by the following steps: receiving, by a server, a desired destination from a client device and a desired charging process that meets or exceeds a charging threshold; verifying the availability of a designated charging station at an expected arrival time of the vehicle at the desired destination; reserving (or establishing a reservation), via the server, the designated charging station when the designated charging station is available at the expected arrival time; receiving information from the controller using the server, including a state of charge and a temperature of the battery; generating an electronic token via the server, wherein the token uniquely identifies the vehicle; and transmitting the electronic token from the server to the client device, wherein the token confirms the reservation and prevents unauthorized use of the designated charging station by another vehicle.

Further, another embodiment, among others, is a reservation system that has a computer-based architecture and that is programmed to perform the aforementioned steps that are recited in the previous paragraph and to communicate with users via respective computer-based client devices.

Other embodiments, systems, apparatus, methods, features, and advantages of the present invention will be apparent to one with skill in the art upon examination of the following drawings and detailed description. It is intended that all such additional embodiments, systems, apparatus, methods, features, and advantages be included within this disclosure, be within the scope of the present invention, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a block diagram of the power and energy reservation system (PERS) and EVSE of the present disclosure.

FIG. 2 is a flow chart showing an example of message data.

FIG. 3 is a flow chart showing an example of a user interface that enables the user to register for the PERS and request a charging process that exceeds a predetermined minimum threshold.

FIG. 4 is a flow chart showing an example of assignment of maximum capacity values for each EVSE installation site and each EVSE.

FIG. 5 is a block diagram of an example of an architecture of the PERS of FIG. 1.

FIG. 6 is a flow chart of a first methodology of the present disclosure that can be implemented by the PERS of FIG. 5.

FIG. 7 is a flow chart of a second methodology of the present disclosure that can be implemented by the PERS of FIG. 5.

### DETAILED DESCRIPTION OF PREFERRED EMBODIMENT(S)

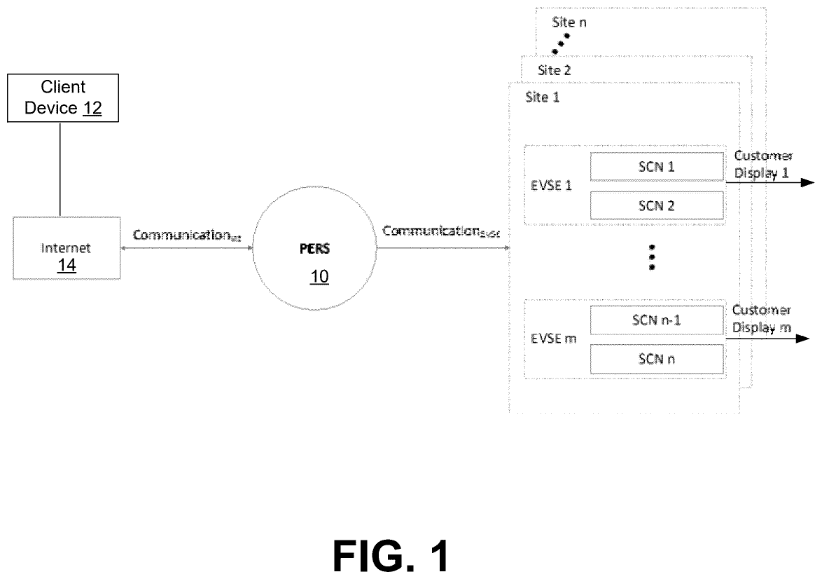

The present disclosure provides a power and energy reservation system (PERS) for EV charging. The PERS 10 is a supervisory control system for a network of EV charging sites. For simplicity, the PERS embodiment is depicted in FIG. 1 as a single, supervisory system with direct communications between client devices 12 associated with respective users via the internet and the EVSE. The preferred embodiment has a central, cloud-based system with associated controls embedded in localized EVSE site controllers.

FIG. 1 also illustrates local communications with the site EVSE as communication_{EVSE} with corresponding communication data detailed in Table A below.

TABLE A

| Name | Acronym | PERS I/O | To/From | Description |
|---|---|---|---|---|
| Customer Vehicle | CVC | Output | Internet | Confirmed Make, Model and Model Year of Customer's vehicle |
| Confirmation | | | | |
| Customer Vehicle Make | CVB | Input | Internet | Customer's vehicle Make (brand) to be used as lookup for range and efficiency, |
| | | | | used in Reserving Energy option |
| Customer Vehicle Model | CVM | Input | Internet | Customer's vehicle Model to be used as lookup for range and efficiency, used in |
| | | | | Reserving Energy option |
| Customer Vehicle Model | CVMY | Input | Internet | Customer's vehicle Model Year to be used as lookup for range and efficiency, |
| Year | | | | used in Reserving Energy option |
| Customer Vehicle SOC | CV SOC | Input | Internet | Customer's vehicle starting State of Charge estimate to be used in calculating |
| Start Estimate | Start | | | amount of energy reserve for the Reserving Energy option |
| EV Range and Efficiency | EVRE | Input | Internet | Specific EV range and efficiency data so that PERS can calculate and confirm a |
| Data | | | | customer selected RE |
| PP Confirmation | PPC | Output | Internet | Confirmation from PERS of price premium applied to reserved charge event |
| PP Customer Acceptance | PPCA | Input | Internet | Acceptance of price premium applied to reserved charge event |
| Premium Pricing | PP | Output | Internet | Premium value of the reserved power or energy communicated to Customer |
| | | | | before the reservation is confirmed |
| RDT Confirmation | RDTC | Output | Internet | Confirmed reservation date and time window assigned to EV customer |
| RE Confirmation | REC | Output | Internet | Confirmed selection by EV customer for choice of minimum energy or vehicle |
| | | | | range to be dispensed for a given charge event; Also includes estimate of |
| | | | | dispensing time. |
| Reservation Date and | RDT | Input | Internet | Reservation date and time window assigned to EV customer |
| Time | | | | |
| Reserved Energy | RE | Input | Internet | Alternative to RMPP, EV customer may choose a minimum amount of energy or |
| | | | | vehicle range to be dispensed for a given charge event |
| Reserved Minimum Peak | RMPP | Input | Internet | Minimum peak power reserved by EV customer for unique charge event |
| Power | | | | |
| RMPP Confirmation | RMMPC | Output | Internet | Confirmed minimum peak power reserved by EV customer for unique charge |
| | | | | event |
| Site Coupler Number | SCN | Output | Internet | Unique EVSE parking spot, dispenser and vehicle coupler assigned to reserved |
| | | | | charge event |
| Site Coupler Number | SCNa | Output | Internet | Assigned EVSE parking spot, dispenser and vehicle coupler assigned to reserved |
| Assigned | | | | charge event |
| Site Coupler Power Max | SCNPMax | Output | EVSE | Peak EVSE vehicle coupler power; Couplers numbered 1 to n per site |
| Site Indentification | SIN | Input | Internet | Unique EVSE site identification number based on location selected by EV |
| Number | | | | customer |
| Site Power Max Capacity | SP_{Max} | N/A | N/A | Peak site power available to be used for charging EVs |

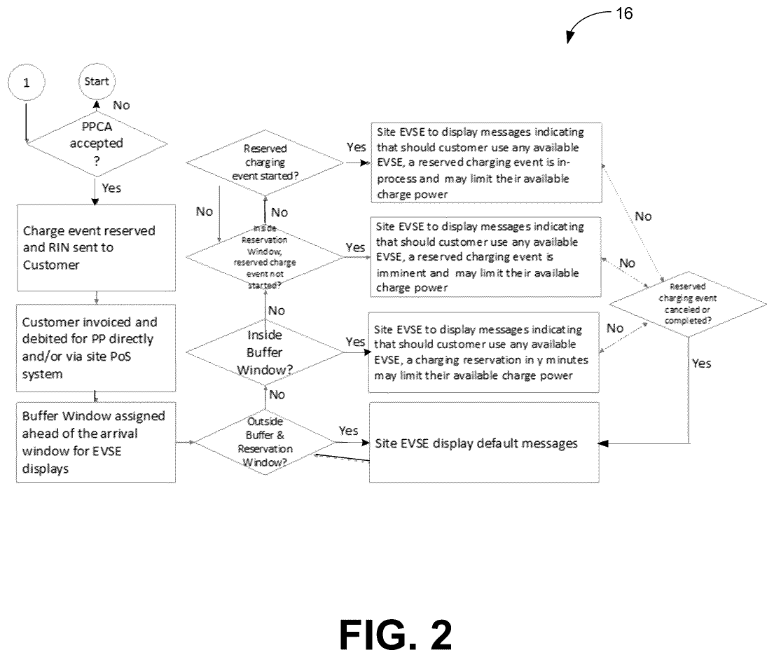

The communication_{Int} indicates all of the data communicated to the PERS 10 via the internet 14 with corresponding communication data detailed in Table 1. FIG. 1 also shows that EV user messaging will be displayed by the site EVSE as indicated by “User Display 1” to “m” with the display data communicated from the PERS 10 to the EVSE via communication_{EVSE}. Detailed message data is shown in FIG. 2 and denoted by reference numeral 16.

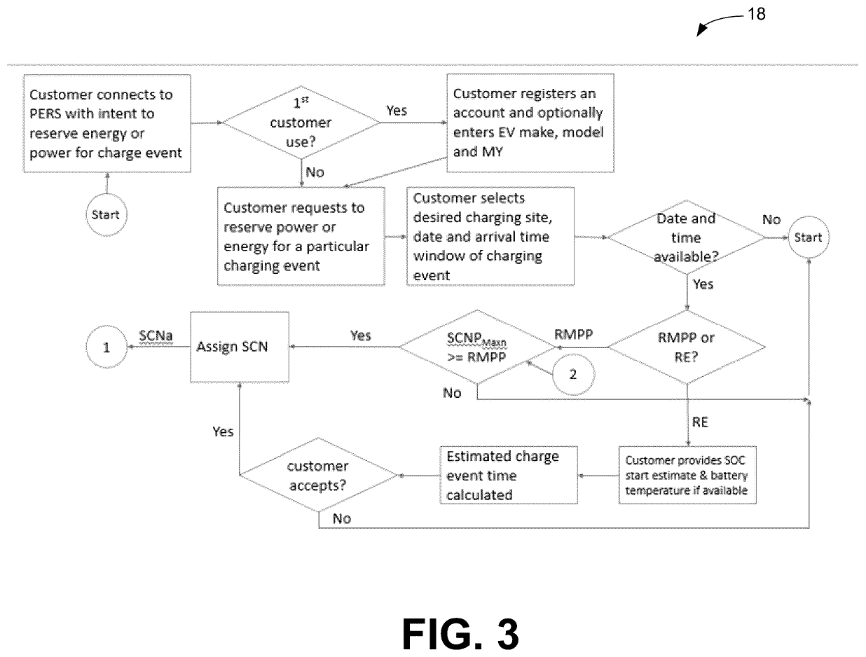

In order to use and access the PERS 10, an individual EV user registers into the PERS 10 by creating an account that includes a user name, a user billing address, a telephone number for short message service (SMS) text messaging (or the client device 12), a user email address, and a user bank card or credit card for billing purposes, as shown in FIG. 3 and denoted by reference numeral 18.

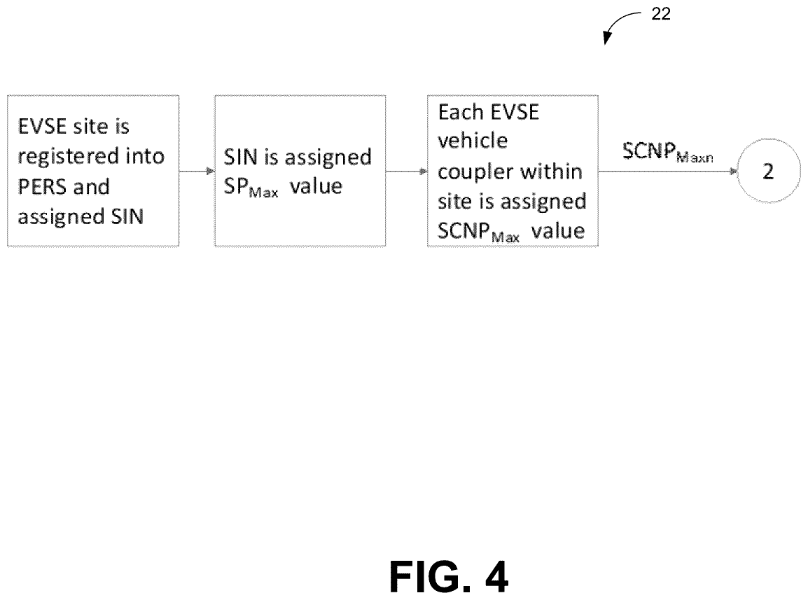

For a given EVSE installation site, site power max capacity value SP_{Max} is set and stored in the PERS 10. Similarly, each EVSE site coupler within a given site is assigned its own max power value site coupler power max n (SCNP_{Maxn}) and stored in the PERS 10. Each SCNP_{Max} capability is set at less than or equal to the site SP_{Max}. The foregoing is illustrated in FIG. 4 and denoted by reference numeral 22.

To reserve power and energy from the PERS 10, a user makes a request to the PERS 10 via the client device 12, for example, an internet-connected personal communications device (PCD), a smartphone, computer, navigation system associated with the EV, a communications device associated with the EV that can access information from one or more on-board controllers of the EV, etc., by providing the information via communication_{Int} as shown in FIG. 3 and Table A, and further described in detail below.

### Site Location

In the preferred embodiment, a unique site identification number (SIN) is assigned to each site in the PERS network based on unique geographic information system (GIS).

### Reservation Date and Time (RDT)

Based on user input, a date/time arrival window will be established and reserved for that particular user. The RDT will be assigned a unique reservation identifier number (RIN). The length of the arrival window is variable and selectable by the user. Longer windows can be charged additional premium.

### Reserved Minimum Peak Power (RMPP)

A user may choose to specify a minimum peak power for the RIN. Once a valid and available SCNP_{Maxn} is selected, the user would be assigned a specific site coupler number (SCN). An alternative embodiment would be for the SCN to be assigned based on the user's vehicle becoming connected to any of the EVSE at the reserved site, rather than a priori.

### Reserved Energy (RE)

A user may choose to specify a minimum amount of energy to be dispensed for the RIN, as an alternative to a minimum peak power request. Equivalently, this could be expressed as vehicle range which would also require the PERS 10 to be informed about the vehicle make, model and year, as well as an estimate of the vehicle state of charge (SOC) at the start of the reserved charging event. Using the foregoing user inputs, the PERS 10 determines how much energy to reserve from the RIN and the amount of time required to dispense it. Once a valid and available RE is selected, the user would be assigned a specific SCN. An alternative embodiment would be for the SCN to be assigned based on the user's vehicle becoming connected to any of the EVSE at the reserved site, rather than a priori.

### Pricing

For the RMPP, RE, and other embodiments, premium pricing (PP) could be set by PERS 10 based on a number of factors including local utility electricity rates, utility demand charges, local EV charging demand, etc. The PERS 10 would also allow the reserved charge event arrival time window to be user defined with a preset base window and an extended window where an additional price premium could be applied. Any PP would be communicated to the user, and the user would have to accept and confirm that PP before the reservation is confirmed. Note that the PP can be negative (i.e., can be lower than base electricity available pricing or even negative pricing under conditions where the user could be paid to discharge their vehicle back into the grid)

### Reallocation of Power at Site

Once the reservation is confirmed, the EVSE SCNₐ is assigned to the RIN, with any remaining power (SP_{Max}−SCNP_{Maxa}), if >0, being made available to the remaining EVSE within the site for other EV charging during the charging event.

### User Messaging

During the RDT window, the reserved EVSE will communicate a message to other potential users that its particular site couplers will not be available to dispense electricity to anyone other than the user that reserved it. Within a fixed/programmable buffer window ahead of the RDT (for example, 30 min), another message will be communicated to other potential users that charging with the reserved EVSE will be disabled or reduced at the RDT start to allow the user with the reservation to access it. Similarly, all other EVSE within the site will notify other potential users without a reservation that available EVSE charging power could be reduced or completely disabled at the start of, or sometime within the RDT. All of this user messaging is designated by user display m, as shown in FIGS. 2 and 3

### Reservation Modifications

Reservations can be modified by a user anytime up to the RDT. An additional charge fee could be applied in the event of a modification, as an option.

### No Shows

A user who does not show up for a reserved charge event that have been assigned a RIN can be charged a financial penalty against a bank card on record.

### Security Token

In some embodiments, a security token can be employed for confirming the reservation. The token can be generated by the PERS 10 and communicated to the user so that the token can be entered at a point of sale (POS) device associated with the EVSE and/or site coupler. The token uniquely identifies the reservation and/or the EV to be charged. The token can be, for example but not limited to, a passcode, etc.

### State of Charge (SOC)

In order to reserve a certain amount of energy in a certain time window, a certain amount of minimum power is required. To give a user the assurance that the user can get the reserved energy or power for the specified time window, the state of charge (SOC) of the battery, or battery module, associated with the EV would be useful. If the battery SOC is not low enough, then this condition could limit charge power. Accordingly, in some embodiments, the SOC from the EV (CV SOC Start) is communicated from the customer associated with the EV to the PERS 10 so that the PERS can evaluate this information when determining the availability of the requested charging process that exceeds the predetermined minimum threshold.

### Battery Temperature

In order to give a user the assurance that the user can get the reserved energy or power for the specified time window, the temperature of the battery associated with the EV would be useful. If the battery is too hot or too cold, the battery could limit charge acceptance (power). Accordingly, in some embodiments, the battery temperature from the EV is communicated from the customer associated with the EV to the PERS 10 so that the PERS 10 can evaluate this information when determining the availability of the requested charging process that exceeds the predetermined minimum threshold.

### PERS Architecture

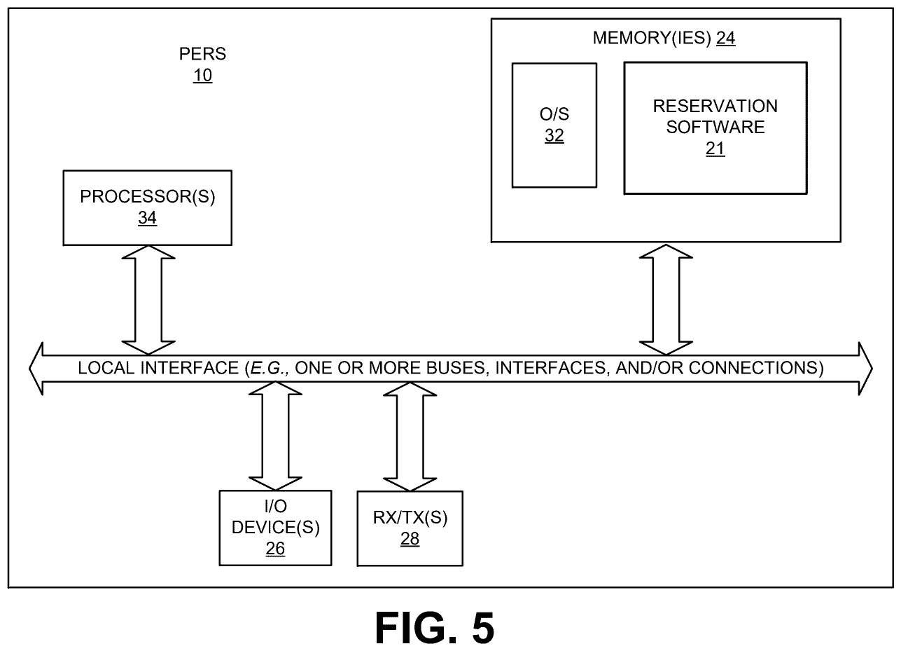

FIG. 5 is a block diagram illustrating an example of the PERS 10, which in the preferred embodiment is a computer server with a computer-based architecture and that is designed to communicate with a plurality of computer-based client devices associated with respective users. In this embodiment, the primary functions of the PERS 10 are implemented in reservation software 21, as shown in FIGS. 5, 6, and 7.

With reference to FIG. 5, the PERS 10 includes at least a processor(s), a memory(ies) 24, an input/output device(ies) (I/O) 26, and a communications device(s) (TX/RX) 28. The singular reference to these terms in this disclosure is intended to include the plural version, as well. All of the foregoing are communicatively coupled via a local interface(s).

In terms of hardware, the memory 24 comprises all volatile and non-volatile memory elements, including but not limited to, RAM, ROM, etc. In terms of software, the memory 24 comprises at least the following software: a suitable operating system (O/S) 32 and the reservation software 21. The computer program code (instructions) associated with the software in memory is executed by the processor 34 in order to perform the methodologies of the present disclosure.

The reservation software 21 (as well as the other software and software logic described in this document), which comprises an ordered listing of executable instructions for implementing logical functions, can be embodied in any non-transitory computer-readable medium for use by or in connection with an instruction execution system, apparatus, or device, such as a computer-based system, processor-containing system, or other system that can fetch the instructions from the instruction execution system, apparatus, or device and execute the instructions.

The input/output devices 26 may include, for example but not limited to, a keyboard, mouse, display, touch screen, etc.

The communications device 28 enables communications with the EVSEs as well as communications with user communications devices (associated with client devices 12).

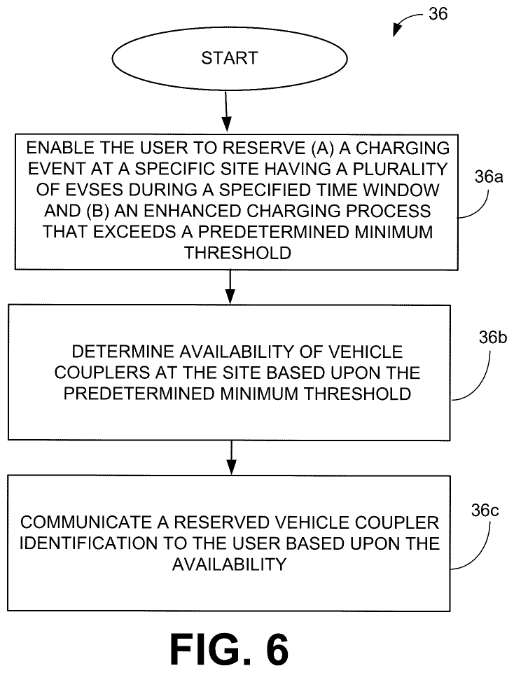

FIG. 6 is a flow chart of a methodology 36 of the present disclosure that can be implemented by a nonlimiting example of the reservation software 21 of the PERS 10 of FIG. 5. The methodology 36 enables a user to reserve a charging event with a charging process that exceeds a minimum charging threshold at electric vehicle supply equipment (EVSE) having electric vehicle (EV) charging couplers to enable charging of an EV with electricity. The processor 34 executes the reservation software 21 in order to at least perform the following steps: enable the user to reserve (a) a charging event at a specific site having a plurality of EVSEs during a specified time window and (b) a charging process that exceeds a predetermined minimum threshold (step 36a); determine availability of site couplers at the site based upon the predetermined minimum threshold (step 36b); and communicate a reserved site coupler identification to the user based upon the availability (step 36c). Note that the reserved predetermined minimum threshold is one of the following: a minimum peak power (RMPP), a minimum reserved energy (RE), or a minimum driving range.

In other embodiments, the processor 34 can additionally execute software instructions associated with the reservation software 21 to perform one or more of the following:
(a) enable the user to specify a length of the time window.
(b) store a site coupler power max (SCNP_{Max}) for each EVSE at the site; determine if any power remains during the reserved time window based upon the reserved predetermined minimum threshold and the actual SCNP; make any remaining power available for use by one or more other site couplers at the site.
(c) charge a higher fee for the charging event as compared to a charging event without the charging process.
(d) communicate the fee to the user; and request confirmation of the fee.
(e) store a site power max capacity value (SP_{Max}) for the site; storing a site coupler power max (SCNP_{Max}) for each EVSE at the site; and determining the availability of each site coupler at the site based upon the reserved charging process, the SP_{Max}, and the SCNP.
(f) notify other users that the reserved site coupler is unavailable during the reserved time window.
(g) notify other users that a reduction in charging capacity will occur during the reserved time window.
(h) receive and store user account information, including a user name, a user billing address, a user telephone number for SMS text messaging (or client device), a user email address, and user bank or credit card billing information; and enable the user to access an internet website to enable the user to make the reservation.
(i) detect a completion of the charging event, and debit the user bank or credit card account a monetary amount for the charging event.
(j) detect a cancelation of the charging event, and debit the user bank or credit card account a monetary amount for the cancelation.
(k) in the case of the minimum driving range, determine an equivalent RE for the reserved charging event based upon a vehicle make, model, and year associated with the user, as well as an estimate of the vehicle state of charge (SOC) at the start of the reserved charging event. The estimate communicated by the user to the PERS.

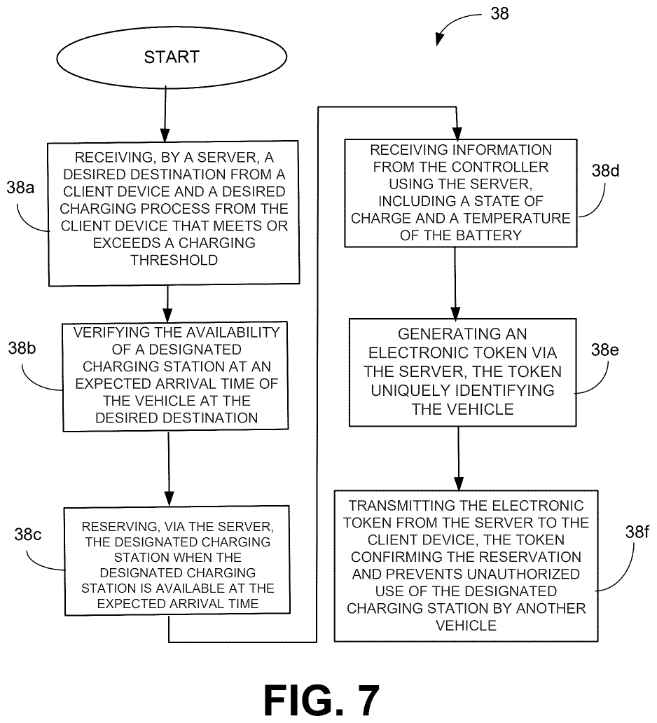

FIG. 7 is a flow chart of a methodology 38 of the present disclosure that can be implemented by another nonlimiting example of the reservation software of the PERS of FIG. 5. The methodology 38 enables a user to reserve a charging event with a charging process that exceeds a minimum charging threshold at electric vehicle supply equipment (EVSE) having electric vehicle (EV) charging couplers to enable charging of an EV with electricity. The processor 34 executes the reservation software 21 in order to at least perform the following steps: receiving, by a server, a desired destination from a client device and a desired charging process from the client device that meets or exceeds a charging threshold (step 38a); verifying the availability of a designated charging station at an expected arrival time of the vehicle at the desired destination (step 38b); reserving, via the server, the designated charging station when the designated charging station is available at the expected arrival time (step 38c); receiving information from the controller using the server, including a state of charge and a temperature of the battery (step 38d); generating an electronic token via the server, the token uniquely identifying the vehicle (step 38e); and transmitting the electronic token from the server to the client device, the token confirming the reservation and prevents unauthorized use of the designated charging station by another vehicle (step 38f). In the preferred embodiment, the electronic token is simply a passcode that the user must enter into a POS device associate with the EVSE and/or coupler.

In other embodiments, the processor 34 can additionally execute software instructions associated with the reservation software 21 to perform one or more of the following:
(a) reserve a length of the time window based upon the expected arrival time of the vehicle at the desired destination.
(b) in the case of the minimum driving range, determine an equivalent RE for the reserved charging event based upon a vehicle make, model, and year associated with the user, as well as an estimate of the vehicle state of charge (SOC) at the start of the reserved charging event.
(c) store a site coupler power max (SCNP_{Max}) for each EVSE at a site having a plurality of site couplers; determine if any power remains during a reserved time window associated with the reservation based upon the reserved predetermined minimum threshold and the SCNP; and make any remaining power available for use by one or more other site couplers at the site.
(d) charge an elevated monetary fee for the reservation that is higher than a charging event without a requirement that the desired charging process meets or exceeds the charging threshold.
(e) communicate the elevated monetary fee to the client device; and request confirmation of the elevated monetary fee.
(f) store a site power max capacity value (SP_{Max}) for a site having a plurality of site couplers; store a site coupler power max (SCNP_{Max}) for each EVSE at the site; and determine the availability of each site coupler at the site based upon the reserved charging process, the SP_{Max}, and the SCNP.
(g) notify other client devices that the reserved site coupler is unavailable during a reserved time window that includes the expected arrival time.
(h) notify other client devices that a reduction in charging capacity will occur during a reserved time window that includes the expected arrival time.
(i) receive and store user account information, the user account information including a user name, a user billing address, a user telephone number for the client device, a user email address, and user bank or credit card account information for billing; and enable the client device to access an internet website to enable the user to make the reservation.
(j) detect a cancelation or a completion of the reservation; and debit a monetary amount from the user bank or credit card account that is appropriate for the cancelation or the completion.
(k) when the expected arrival time is an expected arrival time window, determine a requisite charging window based upon the SOC, the battery temperature, and the reserved charging process; and determine whether the charging window is commensurate with the expected arrival time window. In the event that the requisite charging window cannot occur within the expected arrival time window, then other additional software instructions can be implemented to cause a notification to be sent to the client to advise of the problem.

As previously mentioned, U.S. patent application no. US 2012/0233077 A1, which is incorporated herein by reference and which has a common inventor with the present invention disclosure, describes embodiments of an electric charging station reservation system and method that enable advance reservation of a charging station for an EV based at least in part upon an expected arrival time. The invention concepts of the present invention disclosure can be implemented in combination with such embodiments. More specifically, in such embodiments, when a reservation is made based at least in part upon the expected arrival time, a charging process can also be reserved with the expected arrival time, wherein the charging process corresponds to one that meets or exceeds a threshold.

### VARIATIONS AND MODIFICATIONS

Finally, it should be emphasized that the above-described embodiment(s) of the present invention is merely a possible nonlimiting example of an implementation, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention.

At least the following is claimed:

1. A method for reserving an electric charging station for a vehicle having a controller and a battery and a charging process at the electric charging station that meets or exceeds a charging threshold, the method comprising:
receiving, by a server, a desired destination from a client device and a desired charging process from the client device that meets or exceeds a charging threshold;
verifying the availability of a designated charging station at an expected arrival time of the vehicle at the desired destination;
reserving, via the server, the designated charging station when the designated charging station is available at the expected arrival time;
receiving information from the controller using the server, including a state of charge and a temperature of the battery;
generating an electronic token via the server, the token uniquely identifying the vehicle; and
transmitting the electronic token from the server to the client device, the token confirming the reservation and prevents unauthorized use of the designated charging station by another vehicle.

2. The method of claim 1, further comprising the step of reserving, via the server, a length of the time window based upon the expected arrival time of the vehicle at the desired destination.

3. The method of claim 1, wherein the reserved predetermined minimum threshold is one of the following: a minimum peak power (RMPP), a minimum reserved energy (RE), or a minimum driving range.

4. The method of claim 3, further comprising the step of, in the case of the minimum driving range, determining an equivalent RE for the reserved charging event based upon a vehicle make, model, and year associated with the user, as well as an estimate of the vehicle state of charge (SOC) at the start of the reserved charging event.

5. The method of claim 4, further comprising the steps of:
storing a site coupler power max (SCNP_{Max}) for each EVSE at a site having a plurality of site couplers;
determining if sufficient energy and power remains during a reserved time window associated with the reservation based upon the reserved predetermined minimum threshold and the SCNP; and
making any remaining power available for use by one or more other site couplers at the site.

6. The method of claim 1, further comprising the step of charging an elevated monetary fee for the reservation that is higher than a charging event without a requirement that the desired charging process meets or exceeds the charging threshold.

7. The method of claim 6, further comprising the step of:
communicating the elevated monetary fee to the client device; and
requesting confirmation of the elevated monetary fee.

8. The method of claim 1, further comprising the steps of:
storing a site power max capacity value (SP_{Max}) for a site having a plurality of site couplers;
storing a site coupler power max (SCNP_{Max}) for each EVSE at the site; and
determining the availability of each site coupler at the site based upon the reserved charging process, the SP_{Max}, and the SCNP.

9. The method of claim 1, further comprising the step of notifying other client devices that the reserved site coupler is unavailable during a reserved time window that includes the expected arrival time.

10. The method of claim 1, further comprising the step of notifying other client devices that a reduction in charging capacity will occur during a reserved time window that includes the expected arrival time.

11. The method of claim 1, further comprising the steps of:
receiving and storing user account information, the user account information including a user name, a user billing address, a user telephone number for the client device, a user email address, and user bank or credit card account information for billing; and
enabling the client device to access an internet website to enable the user to make the reservation.

12. The method of claim 11, further comprising the steps of:
detecting a cancelation or a completion of the reservation; and
debiting a monetary amount from the user bank or credit card account that is appropriate for the cancelation or the completion.

13. The method of claim 1, wherein the expected arrival time is an expected arrival time window, and further comprising the steps of:
determining a requisite charging window based upon the SOC, the battery temperature, and the reserved charging process; and
determining whether the charging window can occur within the expected arrival time window.

14. A reservation system for reserving a charging event with a charging process that meets or exceeds a charging threshold at an electric charging station for a vehicle having a controller and a battery, the reservation system comprising:
a client device that enables electronic communications between the reservation system and the user; and
a computer server with a processor and memory, the memory storing software instructions, the processor for executing the instructions in order to perform the following:
receiving, by a server, a desired destination from a client device and a desired charging process from the client device that meets or exceeds a charging threshold;
verifying the availability of a designated charging station at an expected arrival time of the vehicle at the desired destination;
reserving, via the server, the designated charging station when the designated charging station is available at the expected arrival time;
receiving information from the controller using the server, including a state of charge and a temperature of the battery;
generating an electronic token via the server, the token uniquely identifying the vehicle; and
transmitting the electronic token from the server to the client device, the token confirming the reservation and prevents unauthorized use of the designated charging station by another vehicle.

15. The system of claim 14, wherein the memory stores additional instructions that cause the processor to allocate a length of the time window based upon the expected arrival time of the vehicle at the desired destination.

16. The system of claim 14, wherein the reserved predetermined minimum threshold is one of the following: a minimum peak power (RMPP), a minimum reserved energy (RE), or a minimum driving range.

17. The system of claim 16, wherein the memory stores additional instructions that cause the processor to, in the case of the minimum driving range, determine an equivalent RE for the reserved charging event based upon a vehicle make, model, and year associated with the user, as well as an estimate of the vehicle state of charge (SOC) at the start of the reserved charging event.

18. The system of claim 14, wherein the memory stores additional instructions that cause the processor to:
store a site coupler power max (SCNP_{Max}) for each EVSE at a site having a plurality of site couplers;
determine if sufficient energy and power remains during a reserved time window associated with the reservation based upon the reserved predetermined minimum threshold and the SCNP; and
establish as available any remaining power for use by one or more other site couplers at the site.

19. The system of claim 14, wherein the memory stores additional instructions that cause the processor to charge an elevated monetary fee for the reservation that is higher than a charging event without a requirement that the desired charging process meets or exceeds the charging threshold.

20. The system of claim 19, wherein the memory stores additional instructions that cause the processor to:
communicate the elevated monetary fee to the client device; and
request confirmation of the elevated monetary fee.

21. The system of claim 14, wherein the memory stores additional instructions that cause the processor to:
store a site power max capacity value (SP_{Max}) for a site having a plurality of site couplers;
store a site coupler power max (SCNP_{Max}) for each EVSE at the site; and
determine the availability of each site coupler at the site based upon the reserved charging process, the SP_{Max}, and the SCNP.

22. The system of claim 14, wherein the memory stores additional instructions that cause the processor to notify other client devices that the reserved site coupler is unavailable during a reserved time window that includes the expected arrival time.

23. The system of claim 14, wherein the memory stores additional instructions that cause the processor to notify other client devices that a reduction in charging capacity will occur during a reserved time window that includes the expected arrival time.

24. The system of claim 14, wherein the memory stores additional instructions that cause the processor to:
receive and store user account information, the user account information including a user name, a user billing address, a user telephone number for the client device, a user email address, and user bank or credit card account information for billing; and
enabling the client device to access an internet website to enable the user to make the reservation.

25. The system of claim 24, wherein the memory stores additional instructions that cause the processor to:
detect a cancelation or a completion of the reservation; and
debit a monetary amount from the user bank or credit card account that is appropriate for the cancelation or the completion.

26. The system of claim 14, wherein the expected arrival time is an expected arrival time window, and wherein the memory stores additional instructions that cause the processor to:
determine a requisite charging window based upon the SOC, the battery temperature, and the reserved charging process; and
determine whether the charging window can occur within the expected arrival time window.

27. A system for reserving an electric charging station for a vehicle having a controller and a battery and a charging process at the electric charging station that meets or exceeds a charging threshold, the system comprising:
means for receiving a desired destination from a client device and a desired charging process from the client device that meets or exceeds a charging threshold;
means for verifying the availability of a designated charging station at an expected arrival time of the vehicle at the desired destination;
means for reserving the designated charging station when the designated charging station is available at the expected arrival time;
means for receiving information from the controller using the server, including a state of charge and a temperature of the battery;
means for generating an electronic token, the token uniquely identifying the vehicle; and
means for transmitting the electronic token to the client device, the token confirming the reservation and prevents unauthorized use of the designated charging station by another vehicle.
